(19) United States
(12) Patent Application Publication
(10) Pub. No.: US 2022/0190735 A1
(43) Pub. Date: Jun. 16, 2022

(54) CONVERTER INCLUDING ACTIVE CLAMP SWITCH AND SECONDARY SIDE RECTIFIER AND CONTROLLING METHOD OF CONVERTER

(71) Applicant: Sync Power Corp., Taipei City (TW)

(72) Inventors: Hsian-Pei YEE, Taipei City (TW); Chun-Jen HUANG, Taipei City (TW); Li-Min HUANG, Taipei City (TW)

(21) Appl. No.: 17/653,132

(22) Filed: Mar. 2, 2022

Related U.S. Application Data
(63) Continuation-in-part of application No. 17/005,327, filed on Aug. 28, 2020.

(51) Int. Cl. H02M 3/335; H02M 1/34

(52) U.S. Cl. CPC H02M 3/33592; H02M 1/346

(57) ABSTRACT

A controlling method of a converter includes performing a state detecting step and a switch controlling step. The state detecting step is performed to detect an operation state of a secondary side rectifier of the converter from a control winding. The switch controlling step is performed to control an active clamp switch of the converter according to the operation state of the secondary side rectifier. The secondary side rectifier is a diode.

### RELATED APPLICATIONS

The present application is a Continuation-in-part of U.S. application Ser. No. 17/005,327, filed Aug. 28, 2020, which is herein incorporated by reference.

### BACKGROUND

### Technical Field

The present disclosure relates to a flyback converter and a controlling method thereof. More particularly, the present disclosure relates to a flyback converter including an active clamp switch and a secondary side rectifier for energy recovery from active clamp and a controlling method thereof.

### Description of Related Art

A DC voltage is commonly required for operating an electric device. Therefore, an AC-DC power supply or a DC-DC power supply is needed for outputting a rectified DC voltage. A converter is commonly employed in such AC-DC (or DC-DC) power supply to convert a voltage. Many kinds of circuit topologies such as a forward topology, a flyback topology, a CUK topology, a full bridge topology, a half bridge topology and a push pull topology are used in the converter. Conventionally, a converter may include a primary side rectifier having a primary switch and a secondary side rectifier having a secondary side switch for modulating an outputted voltage.

In switch mode power supplies utilizing the aforementioned converters, a Zero Voltage Switching (ZVS) is desired for the primary switch; because of a relatively high voltage on the primary switch that induces a turn-on loss.

The conventional active clamp control has a key problem in a Discontinuous Current Mode (DCM), where the primary switch does not turn on after the transformer energy has been discharged to the output, thus the active clamp transistor is kept “ON” in the discontinued period (both the primary switch and the secondary side rectifier are “OFF”). With the active clamp transistor “ON”, the oscillation involves the snubber capacitor, which is many orders of magnitudes larger than the parasitic capacitance of the primary switch, thus the conduction loss of the active clamp switch makes the snubber loss energy.

### SUMMARY

According to one aspect of the present disclosure, a controlling method of a converter is provided. The controlling method of the converter includes performing a state detecting step to detect an operation state of a secondary side rectifier of the converter from a control winding and performing a switch controlling step to control an active clamp switch of the converter according to the operation state of the secondary side rectifier. The secondary side rectifier is a diode.

According to another aspect of the present disclosure, a controlling method of a converter is provided. The controlling method of the converter includes providing an active clamp switch and a control winding in a primary side circuit and providing a secondary side rectifier in a secondary side circuit; performing a state detecting step to detect an operation state of the secondary side rectifier of the converter from the control winding; and performing a switch controlling step to control the active clamp switch of the converter according to the operation state of the secondary side rectifier. The secondary side rectifier is a diode.

According to further another aspect of the present disclosure, a converter including an active clamp switch and a secondary side rectifier includes a primary side circuit and a secondary side circuit. The primary side circuit includes the active clamp switch and a control winding. The secondary side circuit includes the secondary side rectifier having an operation state. The operation state of the secondary side rectifier of the secondary side circuit is detected from the control winding to control the active clamp switch of the primary side circuit, and the secondary side rectifier is a diode.

### BRIEF DESCRIPTION OF THE DRAWINGS

The present disclosure can be more fully understood by reading the following detailed description of the embodiment, with reference made to the accompanying drawings as follows:

FIG. 1 shows a flow chart of a controlling method of a converter according to a first embodiment of the present disclosure.

FIG. 2 shows a block diagram of a converter according to a second embodiment of the present disclosure.

FIG. 3 shows a flow chart of a controlling method of a converter according to a third embodiment of the present disclosure.

FIG. 4 shows a block diagram of a converter according to a fourth embodiment of the present disclosure.

FIG. 5 shows a block diagram of a controller of the converter of FIG. 4.

FIG. 6 shows a first timing diagram associated with the converter of FIG. 4.

FIG. 7 shows a second timing diagram associated with the converter of FIG. 4.

FIG. 8 shows a third timing diagram associated with the converter of FIG. 4.

FIG. 9 shows a fourth timing diagram associated with the converter of FIG. 4.

FIG. 10 shows a block diagram of a converter according to a fifth embodiment of the present disclosure.

FIG. 11 shows a block diagram of a controller of the converter of FIG. 10.

FIG. 12 shows a block diagram of a converter according to a sixth embodiment of the present disclosure.

FIG. 13 shows a block diagram of a converter according to a seventh embodiment of the present disclosure.

### DETAILED DESCRIPTION

The embodiment will be described with the drawings. For clarity, some practical details will be described below. However, it should be noted that the present disclosure should not be limited by the practical details, that is, in some embodiment, the practical details is unnecessary. In addition, for simplifying the drawings, some conventional structures and elements will be simply illustrated, and repeated elements may be represented by the same labels.

It will be understood that when an element (or device) is referred to as be “coupled to” another element, it can be directly coupled to the other element, or it can be indirectly coupled to the other element, that is, intervening elements may be present. In contrast, when an element is referred to as be “directly coupled to” another element, there are no intervening elements present. In addition, the terms first, second, third, etc. are used herein to describe various elements or components, these elements or components should not be limited by these terms. Consequently, a first element or component discussed below could be termed a second element or component.

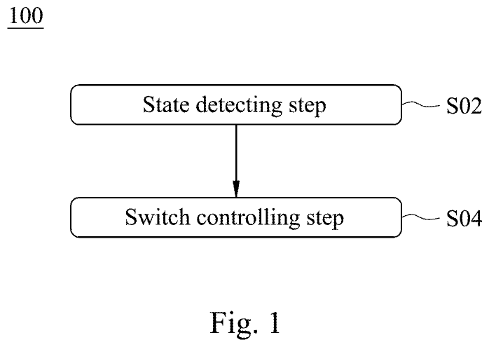

FIG. 1 shows a flow chart of a controlling method 100 of a converter according to a first embodiment of the present disclosure. In FIG. 1, the converter includes an active clamp switch and a secondary side rectifier. The controlling method 100 of the converter includes performing a state detecting step S02 to detect an operation state of the secondary side rectifier of the converter from a control winding and performing a switch controlling step S04 to control the active clamp switch of the converter according to the operation state of the secondary side rectifier. The secondary side rectifier is a diode. Therefore, the controlling method 100 of the converter of the present disclosure utilizes the operation state of the secondary side rectifier to control the active clamp switch instead of shifting the turn-on time of the active clamp switch according to the timing of the primary switch, improving the energy efficiency.

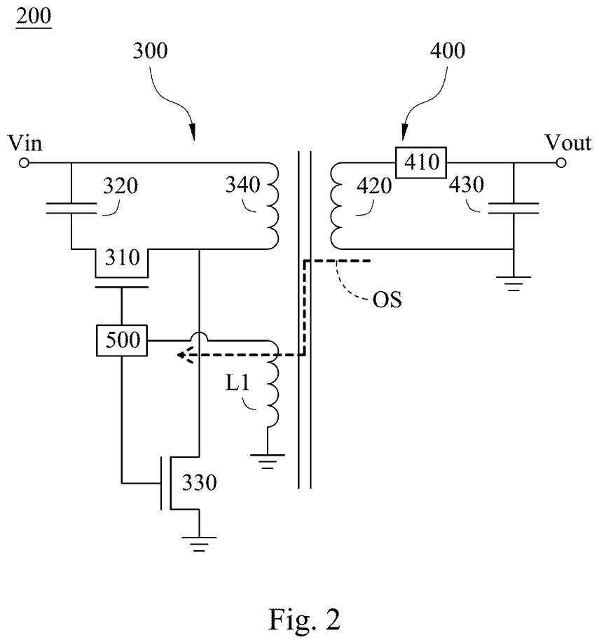

FIG. 2 shows a block diagram of a converter 200 according to a second embodiment of the present disclosure. In FIG. 2, the converter 200 includes a primary side circuit 300, a secondary side circuit 400 and a control unit 500.

The primary side circuit 300 includes an active clamp switch 310, a primary capacitor 320, a primary switch 330, a primary winding 340 and a control winding L1. The active clamp switch 310 may be an NMOS transistor, but the present disclosure is not limited thereto. The primary capacitor 320 is coupled between an input power source and the active clamp switch 310. The input power source generates an input voltage Vin and may be a conventional AC source input including an AC power, a full bridge rectifier, etc. The primary switch 330 has a reflected voltage V_{D} thereon. The primary switch 330 is coupled to the active clamp switch 310, the primary winding 340, a ground and the control unit 500. The primary switch 330 may be an NMOS transistor, but the present disclosure is not limited thereto. The primary winding 340 has two winding ends. One of the two winding ends of the primary winding 340 is coupled to the input power source and the primary capacitor 320. Another of the two winding ends of the primary winding 340 is coupled to the active clamp switch 310 and the primary switch 330. The control winding L1 is coupled to the secondary side circuit 400.

The secondary side circuit 400 includes a secondary side rectifier 410, a secondary winding 420 and a secondary capacitor 430. The secondary side rectifier 410 having an operation state OS. The operation state OS includes a conducting state, a blocking state and a transition state. The conducting state represents that the secondary side rectifier is turned on. The blocking state represents that the secondary side rectifier is turned off. The transition state represents that the secondary side rectifier transits from the conducting state to the blocking state. The secondary side rectifier 410 may be a diode or the NMOS transistor, but the present disclosure is not limited thereto. The secondary winding 420 is coupled to the secondary side rectifier 410. The secondary winding 420 and the primary winding 340 are configured to form an energy transformer to transfer energy from the primary side circuit 300 to the secondary side circuit 400. The secondary capacitor 430 is coupled to the secondary side rectifier 410 and the secondary winding 420. The secondary capacitor 430 generates an output voltage Vout. The control winding L1 is coupled between the active clamp switch 310 and the secondary side rectifier 410 to detect the secondary side rectifier 410 so as to generate the operation state OS of the secondary side rectifier 410.

The control unit 500 is coupled between the active clamp switch 310 and the control winding L1. In other words, the control unit 500 is coupled between the primary side circuit 300 and the secondary side circuit 400. The control unit 500 is configured to implement the controlling method 100 of FIG. 1. The operation state OS of the secondary side rectifier 410 of the secondary side circuit 400 is detected from the control winding L1 to control the active clamp switch 310 of the primary side circuit 300. Therefore, the converter 200 utilizes the operation state OS of the secondary side rectifier 410 to control the active clamp switch 310 instead of shifting the turn-on time of the active clamp switch 310 according to the timing of the primary switch 330, improving the energy efficiency.

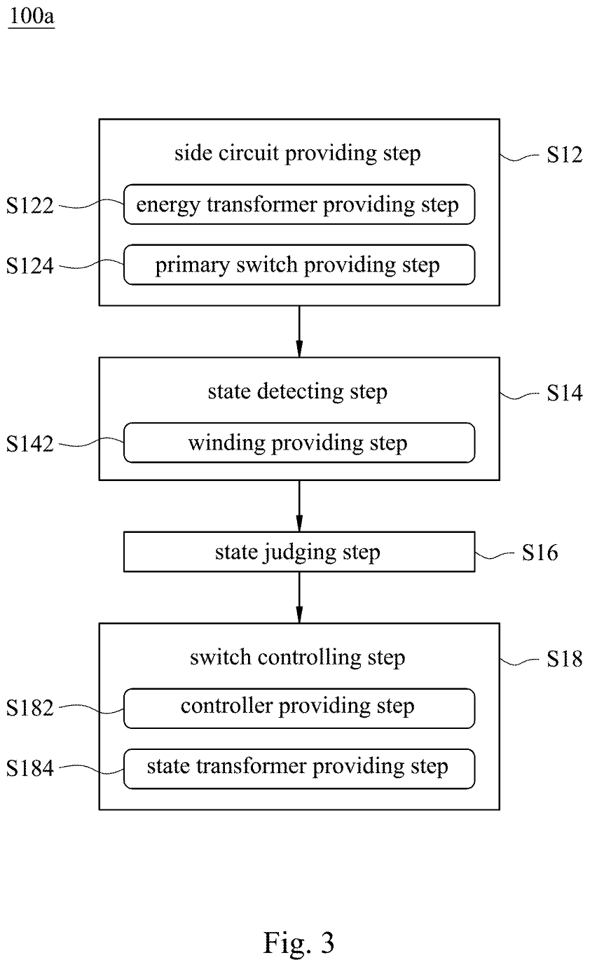

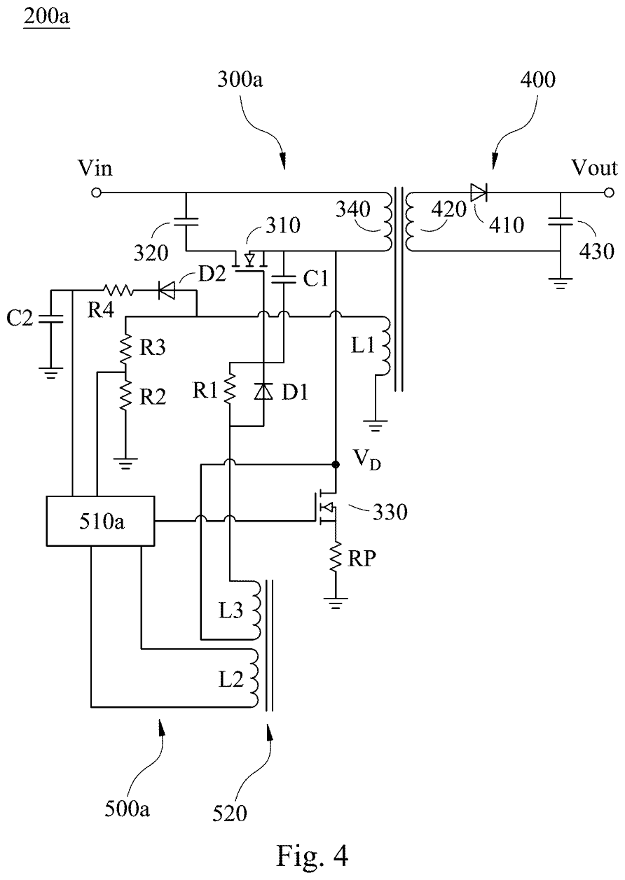

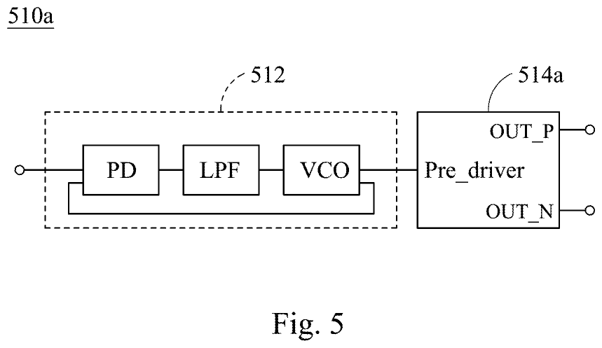

FIG. 3 shows a flow chart of a controlling method 100a of a converter 200a according to a third embodiment of the present disclosure. FIG. 4 shows a block diagram of the converter 200a according to a fourth embodiment of the present disclosure. FIG. 5 shows a block diagram of a controller 510a of the converter 200a of FIG. 4. In FIGS. 3 and 4, the converter 200a includes the active clamp switch 310 and the secondary side rectifier 410. The controlling method 100a of the converter 200a includes a side circuit providing step S12, a state detecting step S14, a state judging step S16 and a switch controlling step S18.

The side circuit providing step S12 is performed to provide the active clamp switch 310 and the secondary side rectifier 410 in the primary side circuit 300 and the secondary side circuit 400, respectively. In addition, the side circuit providing step S12 includes performing an energy transformer providing step S122 and a primary switch providing step S124. The energy transformer providing step S122 is performed to provide an energy transformer coupled between the active clamp switch 310 and the secondary side rectifier 410 to transfer energy. The primary switch providing step S124 is performed to provide a primary switch 330 coupled to the active clamp switch 310 and the energy transformer.

The state detecting step S14 is performed to detect an operation state of the secondary side rectifier 410. The state detecting step S14 includes performing a winding providing step S142 to provide a control winding L1 coupled between the active clamp switch 310 and the secondary side rectifier 410 to detect the secondary side rectifier 410 so as to generate the operation state of the secondary side rectifier 410.

The state judging step S16 is performed to judge whether the operation state of the secondary side rectifier 410 is a conducting state, a blocking state or a transition state.

The switch controlling step S18 is performed to control the active clamp switch 310 according to the operation state of the secondary side rectifier 410. In response to determining that the operation state of the secondary side rectifier 410 is the conducting state in the state judging step S16, the active clamp switch 310 is turned on by the control unit 500 in the switch controlling step S18. In response to determining that the operation state of the secondary side rectifier 410 is the blocking state, the active clamp switch 310 is turned off by the control unit 500 in the switch controlling step S18. In response to determining that the operation state of the secondary side rectifier 410 is the transition state, the active clamp switch 310 is turned on and then turned off to excite a primary side oscillation for primary switch operation. In addition, the switch controlling step S18 includes performing a controller providing step S182 and a state transformer providing step S184. The controller providing step S182 is performed to provide a controller 510a coupled between the control winding L1 and a primary switch 330 to control the primary switch 330 according to the operation state of the secondary side rectifier 410. The state transformer providing step S184 is performed to provide a state transformer 520 coupled between the active clamp switch 310 and the controller 510a to control the active clamp switch 310 according to the operation state of the secondary side rectifier 410.

Therefore, the controlling method 100a of the converter 200a utilizes the operation state of the secondary side rectifier 410 to control the active clamp switch 310 instead of shifting the turn-on time of the active clamp switch 310 according to the timing of the primary switch 330, improving the energy efficiency.

In FIGS. 4 and 5, the converter 200a includes a primary side circuit 300a, a secondary side circuit 400 and a control unit 500a. The detail of the secondary side circuit 400 is the same as the secondary side circuit 400 of FIG. 2, and will not be described again herein. In FIG. 4, the primary side circuit 300a includes an active clamp switch 310, a primary capacitor 320, a primary switch 330, a primary winding 340, a control winding L1 and a resistor RP. The detail of the active clamp switch 310, the primary capacitor 320, the primary switch 330, the primary winding 340 and the control winding L1 is the same as the active clamp switch 310, the primary capacitor 320, the primary switch 330, the primary winding 340 and the control winding L1 of FIG. 2. The resistor RP is coupled between the primary switch 330 and the ground.

The control unit 500a includes a controller 510a, a state transformer 520, a first resistor R1, a second resistor R2, a third resistor R3, a fourth resistor R4, a first diode D1, a second diode D2, a first capacitor C1 and a second capacitor C2. The controller 510a includes a phase lock loop 512 (PLL) and a predriver 514a (Pre_driver), as shown in FIG. 5. The phase lock loop 512 is coupled to the control winding L1 and configured to synchronously control the active clamp switch 310 according to the operation state of the secondary side rectifier 410. The phase lock loop 512 includes a phase detector PD, a low pass filter LPF and a voltage controlled oscillator VCO. The phase detector PD, the low pass filter LPF and the voltage controlled oscillator VCO are connected in series. The predriver 514a with differential outputs OUT_P, OUT_N is connected between the phase lock loop 512 and the state transformer 520. Moreover, the state transformer 520 is coupled between the active clamp switch 310 and the controller 510a to control the active clamp switch 310 according to the operation state of the secondary side rectifier 410. In detail, the state transformer 520 includes a first winding L2 and a second winding L3. The first winding L2 is coupled to the controller 510a. The second winding L3 is coupled to the primary switch 330, the first resistor R1 and the diode D1. In addition, the controller 510a is coupled between the control winding L1 and the primary switch 330 to control the primary switch 330 according to the operation state of the secondary side rectifier 410. The controller 510a is coupled to the first winding L2, the primary switch 330, the second resistor R2 and the third resistor R3. The first resistor R1 and the diode D1 are coupled between the active clamp switch 310 and the second winding L3. The first capacitor C1 is coupled to the first resistor R1, the diode D1 and the active clamp switch 310. The third resistor R3 is coupled between the second resistor R2 and the control winding L1. The second diode D2, the fourth resistor R4 and the second capacitor C2 are coupled in series. The second diode D2 is coupled to the control winding L1 and the third resistor R3. The fourth resistor R4 and the second capacitor C2 are coupled to the controller 510a. The control winding L1 is coupled to the energy transformer, i.e., the control winding L1 is coupled to the secondary winding 420. The control winding L1 is coupled between the controller 510a and the secondary side rectifier 410 to detect the secondary side rectifier 410 so as to generate the operation state of the secondary side rectifier 410.

Therefore, the converter 200a utilizes the operation state of the secondary side rectifier 410 of the secondary side circuit 400 to control the active clamp switch 310 of the primary side circuit 300a instead of shifting the turn-on time of the active clamp switch 310 according to the timing of the primary switch 330, improving the energy efficiency.

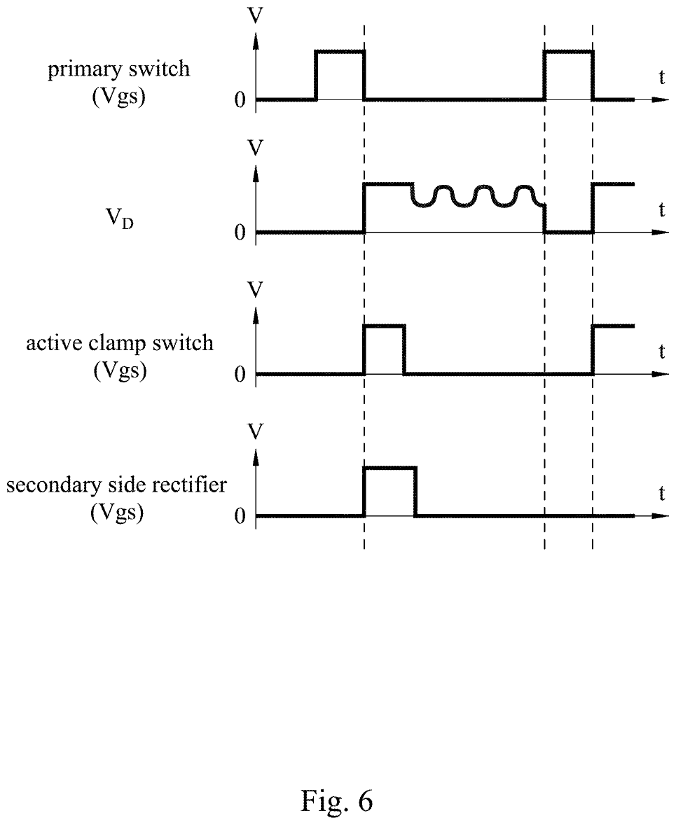

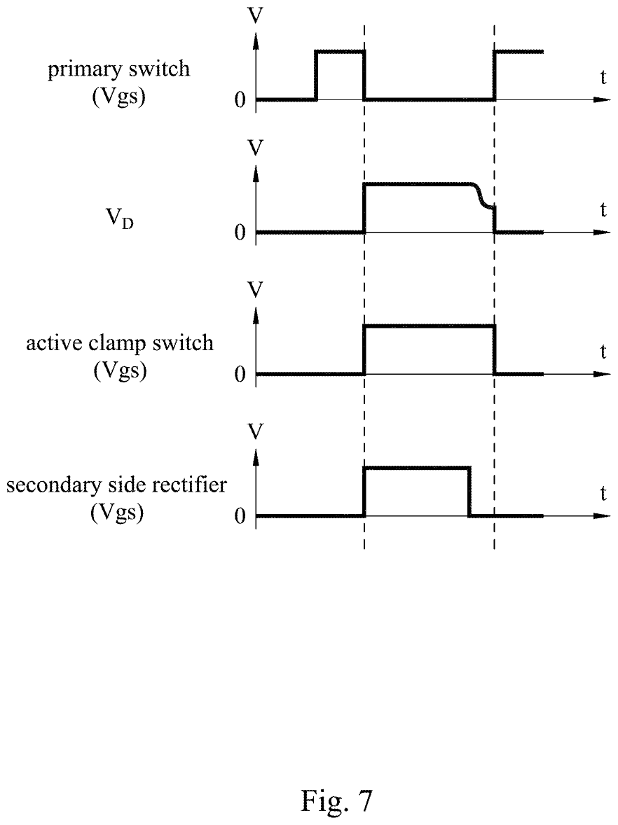

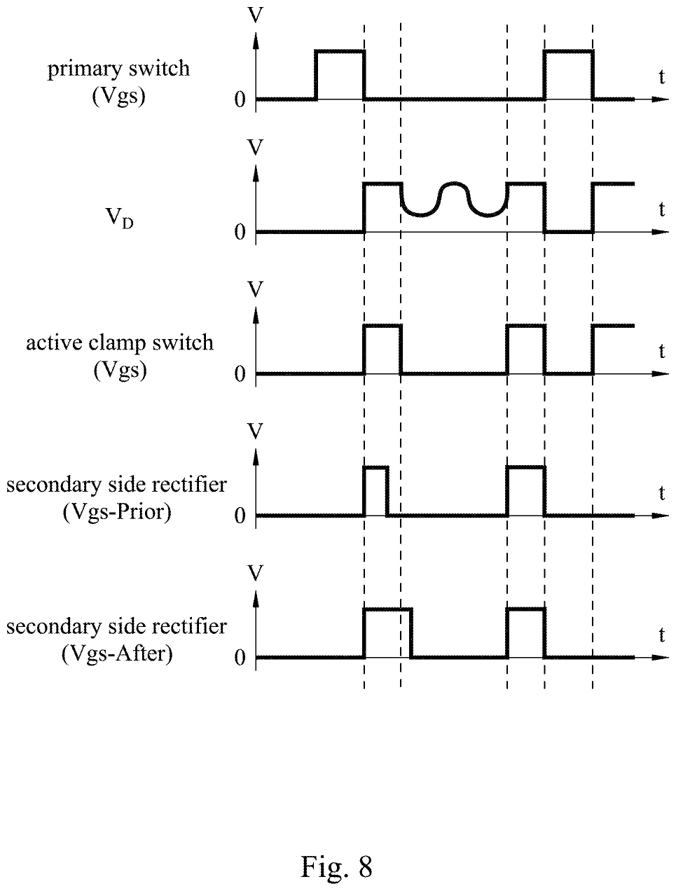

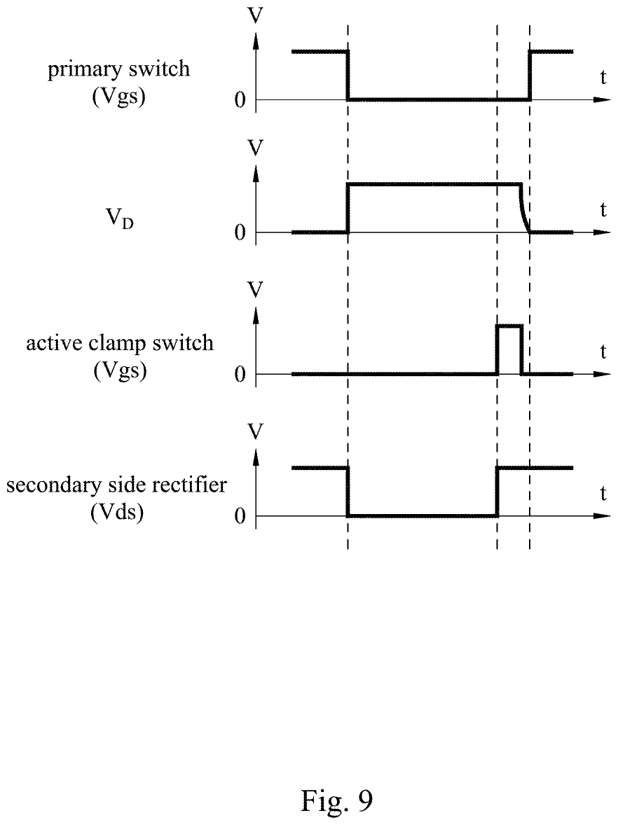

FIG. 6 shows a first timing diagram associated with the converter 200a of FIG. 4. FIG. 7 shows a second timing diagram associated with the converter 200a of FIG. 4. FIG. 8 shows a third timing diagram associated with the converter 200a of FIG. 4. FIG. 9 shows a fourth timing diagram associated with the converter 200a of FIG. 4. In FIGS. 4-9, the operation state of the secondary side rectifier 410 is utilized to control the active clamp switch 310 instead of shifting the turn-on time of the active clamp switch 310 according to the timing of the primary switch 330. The operation state of the secondary side rectifier 410 is reflected at a primary switch node. The primary switch node is located between the active clamp switch 310 and the primary switch 330, and has a reflected voltage V_{D}. When the operation state of the secondary side rectifier 410 is the conducting state (i.e., the secondary side rectifier 410 is turned on), the reflected voltage V_{D} of the primary switch node is equal to Vin plus nVout (i.e., V_{D}=Vin+nVout), where Vin is an input voltage of the converter 200a, n is a transformer winding ratio between the primary winding 340 and the secondary winding 420, and Vout is an output voltage of the converter 200a. The reflected voltage V_{D} of the primary switch node may be utilized to control the active clamp switch 310, specially the turn-off of the active clamp switch 310. The active clamp switch 310 can be turned off prior to, along with or after the drop of the reflected voltage V_{D} (i.e., the reflected voltage V_{D} of the primary switch node is unequal to Vin plus nVout).

In FIG. 6, the first timing diagram represents “Prior”, i.e., the active clamp switch 310 is turned off prior to the drop of the reflected voltage V_{D}. Vgs represents a gate-source voltage of the transistor. The primary capacitor 320 (i.e., a snubber capacitor) does not become a part of a Discontinuous Current Mode (DCM) parasitic oscillation. Thus, no loss will be incurred from the oscillation with the primary capacitor 320, and loss will be only incurred from the oscillation with parasitic capacitance. The timing diagram of “Along” (i.e., the active clamp switch 310 is turned off along with the drop of the reflected voltage V_{D}) is same as the timing diagram of “Prior” in FIG. 6.

In FIG. 7, the second timing diagram represents “After”, i.e., the active clamp switch 310 is turned off after the drop of the reflected voltage V_{D}. When the secondary side rectifier 410 is turned off, the reflected voltage V_{D} is not locked to Vin+nVout, and the active clamp switch 310 is still turned on. The primary capacitor 320 is a part of the oscillation by pushing current back through the energy transformer. When the active clamp switch 310 is turned off, the transformer/leakage inductance demands the same current from the parasitic capacitance so as to cause the reflected voltage V_{D} to be sharply moved lower towards zero and give the primary switch 330 the opportunity to turn on at a Zero Voltage Switching (ZVS) condition.

In FIG. 8, the same ZVS condition can be achieved at a very light load. The active clamp switch 310 may be turned off with “Prior” or “Along”. Loss will be only incurred from the oscillation with parasitic capacitance. Before the primary switch 330 is turned on, the active clamp switch 310 is turned on (i.e., second turn on) to participate in the oscillation, and then quickly turned off to ZVS in the same fashion of FIG. 7.

In FIG. 9, the transition state of the secondary side rectifier 410 is used to control the active clamp switch 310 for ZVS. In response to determining that the operation state of the secondary side rectifier 410 is the transition state (e.g., from the conducting state to the blocking state), the active clamp switch 310 is turned on and then turned off to excite the primary side oscillation for primary switch operation.

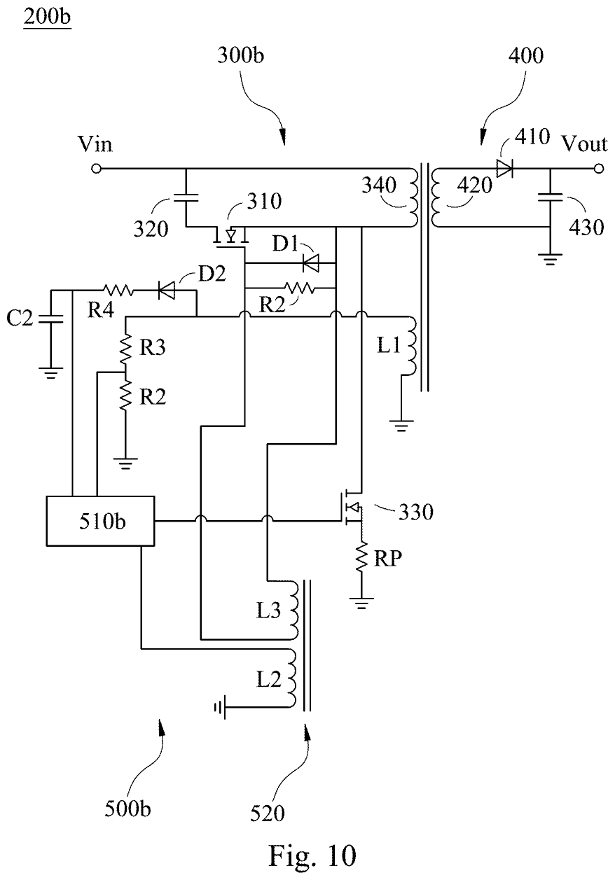

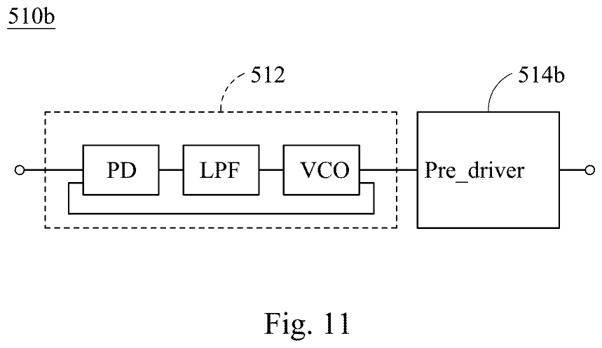

FIG. 10 shows a block diagram of a converter 200b according to a fifth embodiment of the present disclosure. FIG. 11 shows a block diagram of a controller 510b of the converter 200b of FIG. 10. In FIGS. 10 and 11, the converter 200b includes a primary side circuit 300b, a secondary side circuit 400 and a control unit 500b. The primary side circuit 300b includes an active clamp switch 310, a primary capacitor 320, a primary switch 330, a primary winding 340, a control winding L1 and a resistor RP. The structure of the primary side circuit 300b is the same as the structure of the primary side circuit 300a of FIG. 4. The structure of the secondary side circuit 400 is the same as the structure of the secondary side circuit 400 of FIG. 4. The control unit 500b includes a controller 510b, a state transformer 520, a first resistor R1, a second resistor R2, a third resistor R3, a fourth resistor R4, a first diode D1, a second diode D2 and a second capacitor C2. The controller 510b includes a phase lock loop 512 (PLL) and a predriver 514b (Pre_driver). The structure of the state transformer 520, the first resistor R1, the second resistor R2, the third resistor R3, the fourth resistor R4, the first diode D1, the second diode D2, the second capacitor C2 and the phase lock loop 512 is the same as the structure of the state transformer 520, the first resistor R1, the second resistor R2, the third resistor R3, the fourth resistor R4, the first diode D1, the second diode D2, the second capacitor C2 and the phase lock loop 512 of FIG. 4. The predriver 514b with a single output is connected between the phase lock loop 512 and the state transformer 520. The control winding L1 is coupled between the controller 510b and the secondary side rectifier 410 to detect the secondary side rectifier 410 so as to generate the operation state of the secondary side rectifier 410. Therefore, the converter 200b utilizes the operation state of the secondary side rectifier 410 of the secondary side circuit 400 to control the active clamp switch 310 of the primary side circuit 300b instead of shifting the turn-on time of the active clamp switch 310 according to the timing of the primary switch 330, thus improving the energy efficiency.

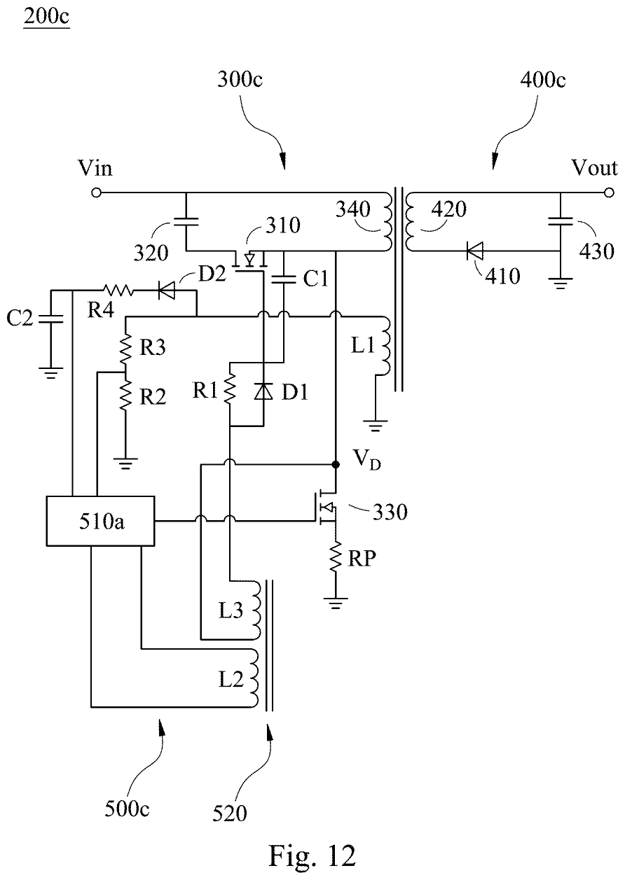

FIG. 12 shows a block diagram of a converter 200c according to a sixth embodiment of the present disclosure. The converter 200c includes a primary side circuit 300c, a secondary side circuit 400c and a control unit 500c. The structure of the primary side circuit 300c and the control unit 500c is the same as the structure of the primary side circuit 300a and the control unit 500a of FIG. 4. The secondary side circuit 400c includes a secondary side rectifier 410, a secondary winding 420 and a secondary capacitor 430. The secondary side rectifier 410 is a diode. An anode of the secondary side rectifier 410 is coupled to the secondary capacitor 430. A cathode of the secondary side rectifier 410 is coupled to the secondary winding 420.

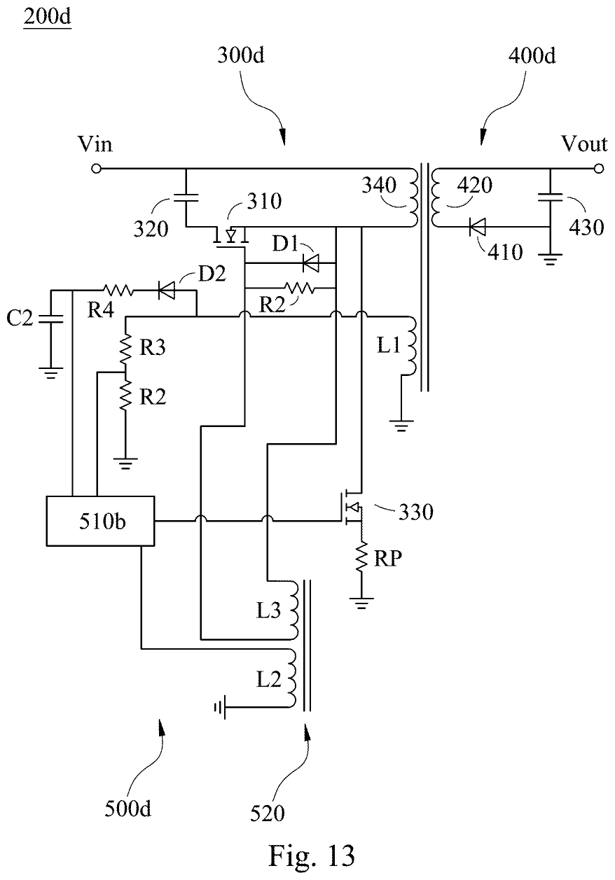

FIG. 13 shows a block diagram of a converter 200d according to a seventh embodiment of the present disclosure. The converter 200d includes a primary side circuit 300d, a secondary side circuit 400d and a control unit 500d. The structure of the primary side circuit 300d and the control unit 500d is the same as the structure of the primary side circuit 300b and the control unit 500b of FIG. 10. The secondary side circuit 400d includes a secondary side rectifier 410, a secondary winding 420 and a secondary capacitor 430. The secondary side rectifier 410 is a diode. An anode of the secondary side rectifier 410 is coupled to the secondary capacitor 430. A cathode of the secondary side rectifier 410 is coupled to the secondary winding 420.

According to the aforementioned embodiments and examples, the advantages of the present disclosure are described as follows.

1. The controlling method of the present disclosure utilizes the operation state of the secondary side rectifier to control the active clamp switch instead of shifting the turn-on time of the active clamp switch according to the timing of the primary switch, so that energy efficiency can be effectively improved.

2. The converter of the present disclosure utilizes the operation state of the secondary side rectifier to control the active clamp switch instead of shifting the turn-on time of the active clamp switch according to the timing of the primary switch, thereby effectively improving energy efficiency.

What is claimed is:

1. A controlling method of a converter, comprising:
performing a state detecting step to detect an operation state of a secondary side rectifier of the converter from a control winding; and
performing a switch controlling step to control an active clamp switch of the converter according to the operation state of the secondary side rectifier;
wherein the secondary side rectifier is a diode.

2. The controlling method of the converter of claim 1, further comprising:
performing a state judging step to judge whether the operation state of the secondary side rectifier is a conducting state, wherein the conducting state represents that the secondary side rectifier is turned on.

3. The controlling method of the converter of claim 2, wherein,
in response to determining that the operation state of the secondary side rectifier is the conducting state, the active clamp switch is turned on; and
in response to determining that the operation state of the secondary side rectifier is a blocking state, the active clamp switch is turned off.

4. The controlling method of the converter of claim 1, further comprising:
performing a state judging step to judge whether the operation state of the secondary side rectifier is a transition state, wherein the transition state represents that the secondary side rectifier transits from a conducting state to a blocking state.

5. The controlling method of the converter of claim 1, wherein,
in response to determining that the operation state of the secondary side rectifier is a transition state, the active clamp switch is turned on and then turned off to excite a primary side oscillation for primary switch operation.

6. The controlling method of the converter of claim 1, further comprising:
providing an energy transformer coupled between the active clamp switch and the secondary side rectifier to transfer energy; and
providing a primary switch coupled to the active clamp switch and the energy transformer.

7. The controlling method of the converter of claim 1, wherein the control winding is coupled between the active clamp switch and the secondary side rectifier to detect the secondary side rectifier so as to generate the operation state of the secondary side rectifier, and the operation state is one of a conducting state, a blocking state and a transition state.

8. The controlling method of the converter of claim 7, wherein the switch controlling step comprises:
providing a controller coupled between the control winding and a primary switch to control the primary switch according to the operation state of the secondary side rectifier.

9. The controlling method of the converter of claim 8, wherein the switch controlling step further comprises:
providing a state transformer coupled between the active clamp switch and the controller to control the active clamp switch according to the operation state of the secondary side rectifier.

10. The controlling method of the converter of claim 8, wherein the controller comprises a phase lock loop coupled to the control winding, and the phase lock loop is configured to synchronously control the active clamp switch according to the operation state of the secondary side rectifier.

11. A controlling method of a converter, comprising:
providing an active clamp switch and a control winding in a primary side circuit and providing a secondary side rectifier in a secondary side circuit;
performing a state detecting step to detect an operation state of the secondary side rectifier of the converter from the control winding; and
performing a switch controlling step to control the active clamp switch of the converter according to the operation state of the secondary side rectifier;
wherein the secondary side rectifier is a diode.

12. The controlling method of the converter of claim 11, further comprising:
performing a state judging step to judge whether the operation state of the secondary side rectifier is a conducting state, wherein the conducting state represents that the secondary side rectifier is turned on.

13. The controlling method of the converter of claim 12, wherein,
in response to determining that the operation state of the secondary side rectifier is the conducting state, the active clamp switch is turned on; and
in response to determining that the operation state of the secondary side rectifier is a blocking state, the active clamp switch is turned off.

14. The controlling method of the converter of claim 11, further comprising:
performing a state judging step to judge whether the operation state of the secondary side rectifier is a transition state, wherein the transition state represents that the secondary side rectifier transits from a conducting state to a blocking state.

15. The controlling method of the converter of claim 14, wherein,
in response to determining that the operation state of the secondary side rectifier is the transition state, the active clamp switch is turned on and then turned off to excite a primary side oscillation for primary switch operation.

16. The controlling method of the converter of claim 11, further comprising:
providing an energy transformer coupled between the active clamp switch and the secondary side rectifier to transfer energy; and
providing a primary switch coupled to the active clamp switch and the energy transformer in the primary side circuit.

17. The controlling method of the converter of claim 11, wherein the control winding is coupled between the active clamp switch and the secondary side rectifier to detect the secondary side rectifier so as to generate the operation state of the secondary side rectifier, and the operation state is one of a conducting state, a blocking state and a transition state.

18. The controlling method of the converter of claim 17, wherein the switch controlling step further comprises:
providing a controller coupled between the control winding and a primary switch to control the primary switch according to the operation state of the secondary side rectifier.

19. The controlling method of the converter of claim 18, wherein the switch controlling step comprises:
providing a state transformer coupled between the active clamp switch and the controller to control the active clamp switch according to the operation state of the secondary side rectifier.

20. The controlling method of the converter of claim 18, wherein the controller comprises a phase lock loop coupled to the control winding, and the phase lock loop is configured to synchronously control the active clamp switch according to the operation state of the secondary side rectifier.

21. A converter including an active clamp switch and a secondary side rectifier, comprising:
a primary side circuit, wherein the primary side circuit comprises the active clamp switch and a control winding; and
a secondary side circuit, wherein the secondary side circuit comprises the secondary side rectifier having an operation state;
wherein the operation state of the secondary side rectifier of the secondary side circuit is detected from the control winding to control the active clamp switch of the primary side circuit, and the secondary side rectifier is a diode.

22. The converter including the active clamp switch and the secondary side rectifier of claim 21, wherein,
the primary side circuit further comprises a primary winding coupled to the active clamp switch; and
the secondary side circuit further comprises a secondary winding coupled to the secondary side rectifier;
wherein the primary winding and the secondary winding are configured to form an energy transformer to transfer energy from the primary side circuit to the secondary side circuit;
wherein the primary side circuit further comprises a primary switch coupled to the active clamp switch and the primary winding.

23. The converter including the active clamp switch and the secondary side rectifier of claim 21, further comprising:
a control unit coupled between the active clamp switch and the control winding, wherein the control unit is configured to implement a controlling method of the converter comprising:
performing a state detecting step to detect the operation state of the secondary side rectifier; and
performing a switch controlling step to control the active clamp switch according to the operation state of the secondary side rectifier, wherein the operation state is one of a conducting state, a blocking state and a transition state.

24. The converter including the active clamp switch and the secondary side rectifier of claim 23, wherein,
the control winding is coupled between the active clamp switch and the secondary side rectifier to detect the secondary side rectifier so as to generate the operation state of the secondary side rectifier; and
the control unit comprises:
a controller coupled between the control winding and a primary switch to control the primary switch according to the operation state of the secondary side rectifier; and
a state transformer coupled between the active clamp switch and the controller to control the active clamp switch according to the operation state of the secondary side rectifier.
